(19) United States
(12) Patent Application Publication
(10) Pub. No.: US 2007/0043890 A1
(43) Pub. Date: Feb. 22, 2007

(54) Data block transfer and decompression

(76) Inventor: Casey L. Miller, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/208,215

(22) Filed: Aug. 19, 2005

(51) Int. Cl. G06F 13/12

(52) U.S. Cl. 710/68

(57) ABSTRACT

Various embodiments for transferring and/or decompressing data blocks are described. In an embodiment, a memory transfer engine transfers a first data block from a nonvolatile memory to a volatile memory. A processor may decompress the transferred first data block. Furthermore, the memory transfer engine may initiate a transfer of a second data block from the nonvolatile memory to the volatile memory prior to the processor completing the decompression of the transferred first data block.

### BACKGROUND

The present description generally relates to processing electronic data. More particularly, an embodiment relates to decompressing a data block while another data block is transferred from a nonvolatile to a volatile memory.

As digital cameras become cheaper and capable of more image manipulation features (e.g. red-eye detection and correction, image resizing, panorama stitching, etc.), an ever increasing portion of the image capturing market is moving to digital cameras. With the increase in features, however, digital cameras use an increasing amount of nonvolatile data storage to store more sophisticated boot data.

When compared with volatile data storage devices, nonvolatile storage devices are slower. As such, some digital cameras may transfer the data stored in nonvolatile memory to a faster volatile memory prior to utilizing the boot data, e.g., to start a digital camera. This may increase delays associated with starting a digital camera, for instance, when compared with a typical film-based camera. Additionally, nonvolatile memory devices are more expensive than volatile memory devices. Hence, as digital cameras utilize more data (that is to be stored in a nonvolatile memory), they become more expensive to manufacture.

### BRIEF DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates various components of a digital camera, according to an embodiment.

FIG. 2 illustrates some components of a digital camera processing unit, according to an embodiment.

FIG. 3 illustrates a flow diagram of a method for compressing, decompressing, or transferring data blocks, according to various embodiments.

FIG. 4 illustrates various components of a computing device which may be utilized to implement portions of the techniques discussed herein, according to an embodiment.

### DETAILED DESCRIPTION

Various embodiments for transferring and/or decompressing data blocks are described. In one embodiment, a memory transfer engine transfers a plurality of data blocks from a nonvolatile memory to a plurality of data buffers in a volatile memory. As the plurality of data blocks are being transferred, a processor decompresses the transferred data blocks and stores the decompressed data in the volatile memory. Transfer of a next data block is initiated prior to completing the decompression of a previous block.

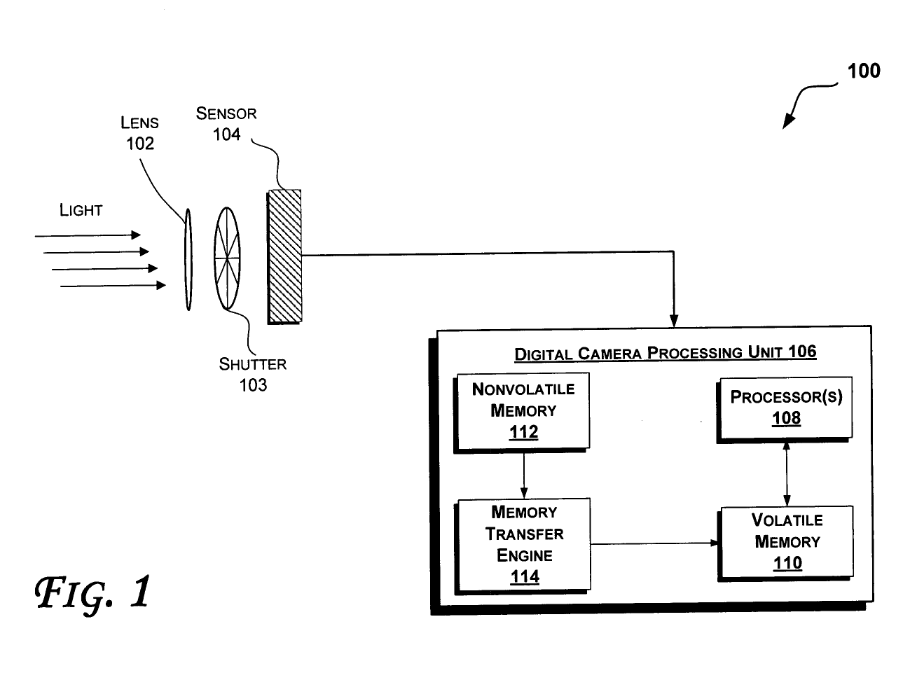

The techniques discussed herein may be applied to various devices that may include a computing or processing unit, such as a printer, scanner, digital camera, personal digital assistant (PDA), cellular phone, or the like. FIG. 1 illustrates various components of a digital camera 100, according to an embodiment. The digital camera 10 may be utilized for capturing images in digital format. The camera 100 may be a stand-alone camera or a camera incorporated into another device (such as a PDA, a cell phone, or the like).

The camera 100 includes a lens 102 that is exposed to light rays. Multiple lens configurations may be utilized to capture the light rays such as different types of lenses (e.g., zoom, fish eye, wide angle, etc.). The camera 100 may further include a shutter 103. The shutter 103 may control exposure of a sensor 104 to the light rays passing through the lens 102. As illustrated in FIG. 1, the shutter 103 may be located between the sensor 104 and the lens 102. The shutter 103 may be activated by a button on the camera or remotely (e.g., by an infra red or radio frequency remote control).

The sensor 104 may be any suitable image capture sensor such as a complimentary metal-oxide semiconductor (CMOS) or a charge-coupled device (CCD). In an embodiment, the sensor 104 may be selectively activated or exposed to light rays without utilizing a physical barrier (such as the shutter 103). Moreover, a more simplified mechanism (such as a sensor cover) may be utilized to protect the lens 102 and/or the sensor 104 from environmental elements (e.g., sun rays, dust, water, humidity, or the like).

The digital camera 100 further includes a digital camera processing unit 106 that is coupled to the sensor 104. The processing unit 106 includes one or more processors (108) coupled to a volatile memory 110. The volatile memory 110 may be accessed by the processors 108 to fetch or store data such as data utilized during the start-up of the digital camera 100 (also referred to as boot data), configuration data (such as camera settings), or the like. The volatile memory 110 may further be utilized to temporarily store and/or process data such as images captured by the sensor 104. The volatile memory 110 may include any suitable types of memory such as random access memory (RAM), dynamic RAM (DRAM), synchronous DRAM (SDRAM), static RAM (SRAM), combinations thereof, or the like.

As shown in FIG. 1, the processing unit 106 may include nonvolatile memory 112, such as read-only memory (ROM), erasable programmable ROM (EPROM), electrically EPROM (EEPROM), a hard disk drive, or the like. In one embodiment, the EEPROM may be flash memory, which is a form of EEPROM that allows multiple memory locations to be erased or written in one programming operation. The data stored on the nonvolatile memory 112 may be utilized to provide configuration data (such as camera settings), boot data, or the like (e.g., during start-up or upon request).

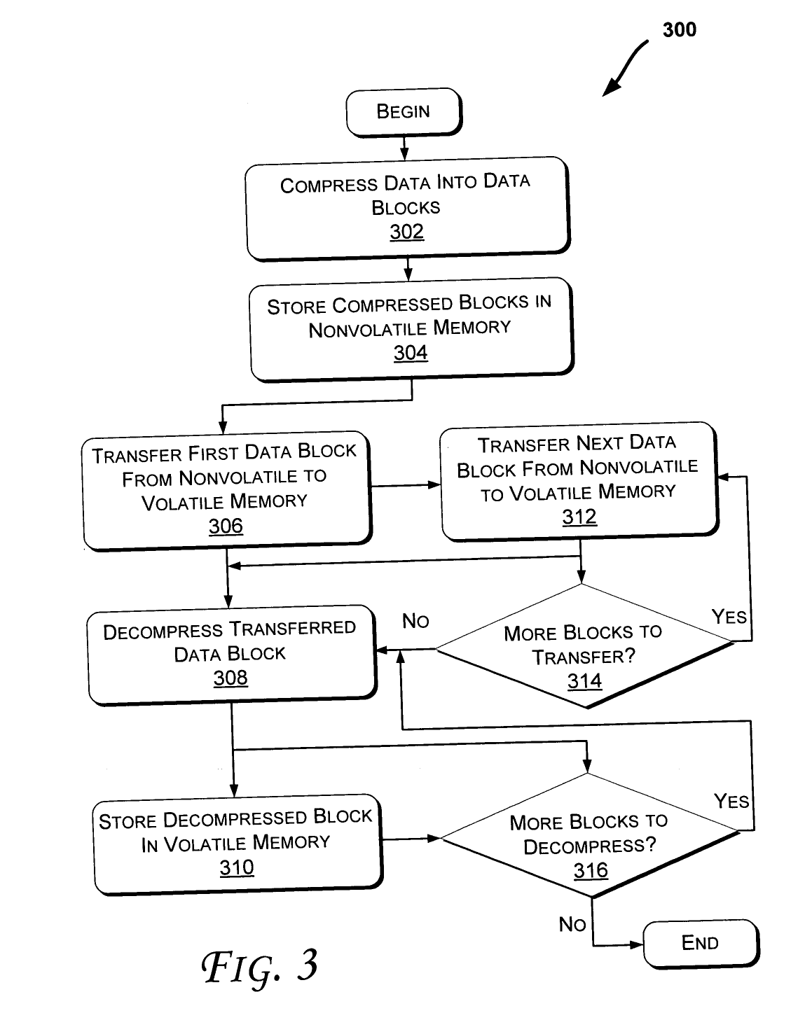

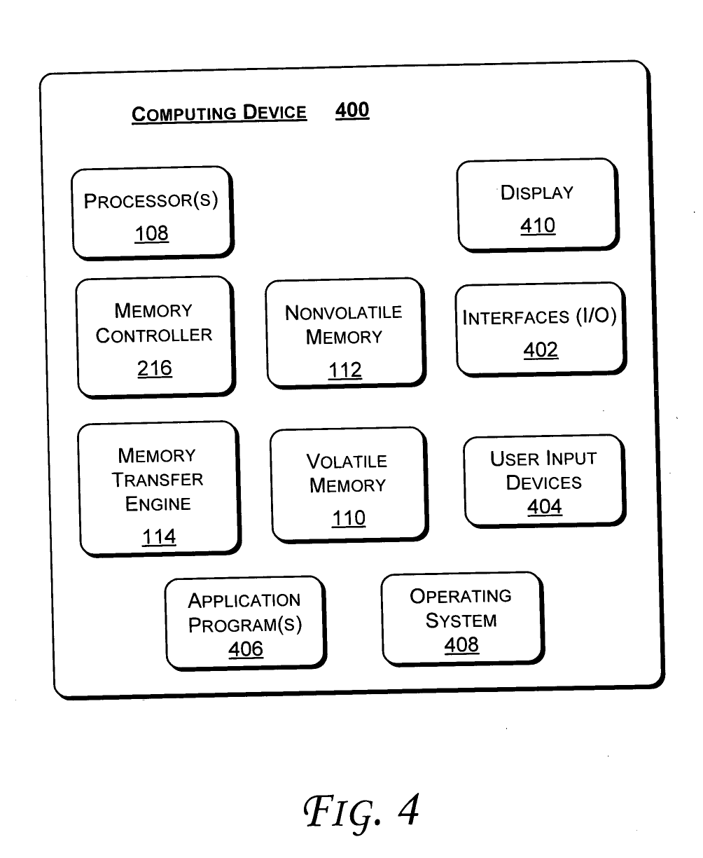

The digital camera 100 may also include a memory transfer engine 114 to transfer data from the nonvolatile memory 112 (e.g., in form data blocks) to the volatile memory 110 as will be further discussed with reference to FIGS. 3 and 4. The memory transfer engine 114 may comprise hardware, software, and/or firmware to control the data transfer from the nonvolatile memory 112 to the volatile memory 110. Alternatively, the memory transfer engine 114 may perform the data transfer at the direction of another component of the camera 100 (e.g., the processors 108) or a component external to the camera 100 (e.g., another computing device such as the device 400 of FIG. 4). Furthermore, the memory transfer engine 114 may be implemented as an application-specific integrated circuit (ASIC), a programmable logic array (PLA), or the like.

The digital camera 100 may include other removable/non-removable, volatile/nonvolatile computer storage media (not shown). By way of example, the nonvolatile memory 112 may include one or more of the following: a floppy disk, an optical disk drive (such as a compact disc ROM (CD-ROM) and/or digital versatile disk (DVD)), a tape (e.g., in case of digital video cameras), or the like.

In an embodiment, the digital camera 100 may utilize one or more external facilities (such as the computing device discussed with reference to FIG. 4) to process and/or store data instead of or in addition to the digital camera processing unit 106. In such an embodiment, the digital camera 100 may also be controlled by the external facility. This embodiment may free a photographer from manually modifying the camera parameters between shots, enabling the photographer to focus on shooting better images. Furthermore, data may be exchanged with the external facility through a wired connection (e.g., universal serial bus (USB), Fire Wire (e.g., Institute of Electrical & Electronics Engineers (IEEE) 1394 or the like) and/or wireless connection (e.g., IEEE 802.11 (and its varieties), cellular network, radio frequency, etc.).

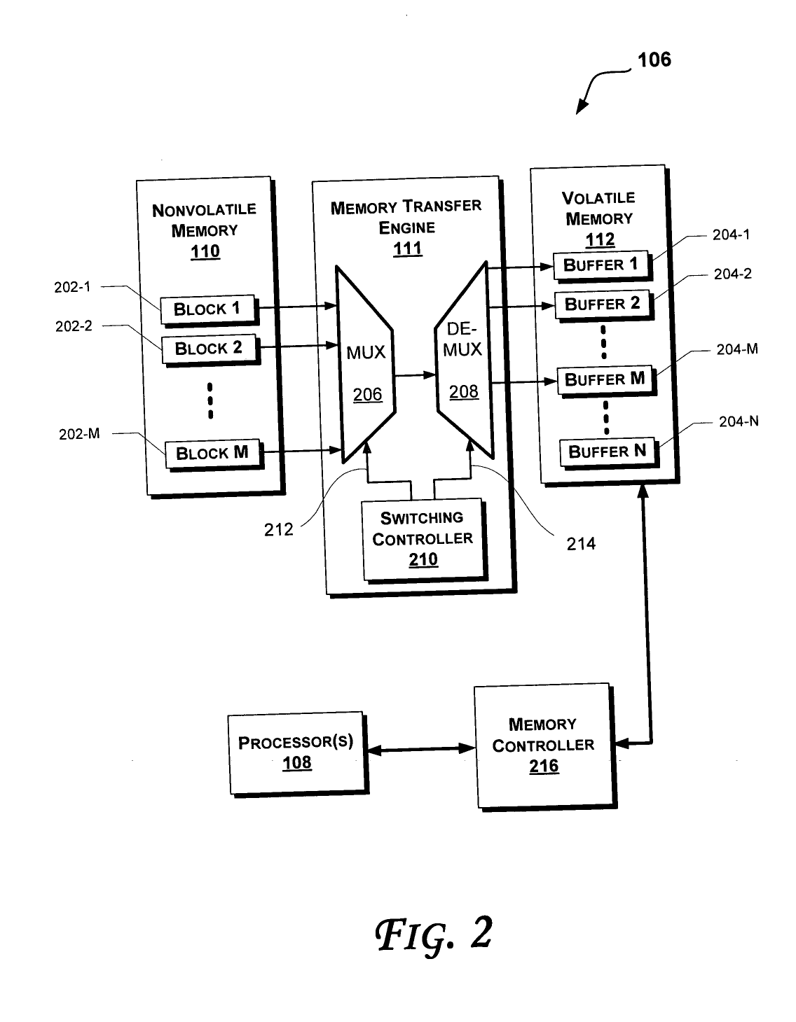

FIG. 2 illustrates some components of a digital camera processing unit, according to an embodiment. For example, FIG. 2 illustrates further details regarding an embodiment of the digital camera processing unit 106 of FIG. 1. The nonvolatile memory 112 includes a plurality of data blocks (202-1 through 202-M) that are each transferred to a plurality of data buffers (204-1 through 204-M) in the volatile memory 110 by the memory transfer engine 114. As illustrated in FIG. 2, the memory transfer engine 114 may include a multiplexer (MUX) 206 coupled to the plurality of data blocks (202-1 through 202-M). Moreover, the memory transfer engine 114 may include a demultiplexer (DEMUX) 208 coupled to the plurality of data buffers (204-1 through 204-M). The memory transfer engine 114 may further include a switching controller 210 coupled to the MUX 206 and DEMUX 208 to control which inputs or outputs (of the MUX 206 and DEMUX 208, respectively) are selected. Hence, each data block (202-1 through 202-M) may pass through the MUX 206 and DEMUX 208 and be stored in a respective data buffer (204-1 though 204-M).

The volatile memory 110 may be coupled to the processors 108 through a memory controller 216. As shown in FIG. 2, the volatile memory 110 may include more than the data buffers 204-1 through 204-M (e.g., data buffers 204-M through 204-N) that may be accessed by the processors (108) through the memory controller 216 for fetching and/or storing data such as discussed with reference to FIG. 1 In an embodiment, the memory controller 216 may include the memory transfer engine 114.

As discussed with reference to FIG. 1, the memory transfer engine 114 may comprise hardware, software, and/or firmware to control the data transfer from the nonvolatile memory 112 to the volatile memory 110 (e.g., via the switching controller 210, MUX 206, and DEMUX 208). Alternatively, the memory transfer engine 114 may perform the data transfer at the direction of another component of the camera 100 of FIG. 1 (e.g., the processors 108) or a component external to the camera 100 (e.g., another computing device such as the device 400 of FIG. 4). Furthermore, the memory transfer engine 114 may be implemented as an ASIC, a PLA, or the like.

FIG. 3 illustrates a flow diagram of a method 300 for compressing, decompressing, or transferring data blocks, according to various embodiments. The stages of the method 300 may be performed by hardware, software, firmware, or combinations thereof. For example, the components of FIGS. 1, 2, and 4 may perform various stages of the method 300. Furthermore, the method 300 may be applied in various devices that include a computing or processing unit (e.g., 106 of FIGS. 1-2 or 400 of FIG. 4), such as a printer, scanner, digital camera, personal digital assistant (PDA), cellular phone, or the like.

Referring to FIGS. 1-3, the method 300 starts by compressing data into data blocks (302). The data that is compressed may be any suitable type of data such as firmware that may be utilized for booting a computing device, a digital camera, a PDA, a cellular phone, a scanner, a printer, or the like. For instance, suitable lossless compression techniques such as Lempel-Ziv-Oberhumer (LZO) or Lempel-Ziv-Welch (LZW) may be used to perform the stage 302. The data compression (302) may enable the use of a smaller nonvolatile memory (112) which in turn may reduce manufacturing costs.

In an embodiment, the compression/decompression technique used (302) may be unbalanced, e.g., where the compression takes longer than decompression. This may allow for an optimized decompression, for example, where decompression occurs more frequently than compression. For example, with respect to boot data, compression may only occur once, e.g., when the boot data is stored in a nonvolatile memory (e.g., 112); whereas, decompression may be performed many times (e.g., each time the camera 100 or computing device 400 is started). In one embodiment, the data blocks may have the same size (e.g., 16 kB each in an embodiment). Also, data may be compressed into blocks (302) to allow parallel decompression (308) and transfer (306 and/or 312) of the data blocks. Further, any suitable processor (e.g., 108) may be utilized to perform the compression (302).

At a stage 304, the compressed data blocks (302) may be stored in a nonvolatile memory (112), e.g., data blocks 202-1 through 202-M. the memory transfer engine 114 transfers a first data block (e.g., one of the data blocks 202-1 through 202-M) to a data buffer in the volatile memory 110 (e.g., one of the data buffers 204-1 through 204-M). As the processor(s) 108 decompresses (308) the transferred data block and stores the decompressed data (310) in the volatile memory 112 (e.g., in data blocks 204-M through 204-N), the memory transfer engine 114 may transfer the next data block (312) from the nonvolatile memory 112 to the volatile memory 112. Hence, the memory transfer engine 114 may initiate the transfer of a second data block from the nonvolatile memory 112 to the volatile memory 110 prior to the processor(s) 108 completing the decompression of the transferred first data block (308).

At a stage 314, the memory transfer engine 114 (or another component of the unit 106 such as the processor(s) 108) determines whether more data blocks are to be transferred. If so, the method 300 resumes with the stage 312; otherwise, the method 300 resumes with the stage 308 to decompress the transferred data blocks. The processor 108 continues decompressing transferred data blocks and storing the decompressed data in the volatile memory 110 (310) as long as more blocks are to be decompressed (316). Once all the transferred blocks are decompressed (308) and/or the decompressed data is stored in the volatile memory 110 (310), the method 300 terminates. Overlapping (or parallelizing) the data block transfer (e.g., 306 or 312) with the decompression (308) may provide for a shorter combined transfer and decompression time than techniques that transfer all the compressed data to volatile memory prior to commencing decompression.

FIG. 4 illustrates various components of a computing device 400 which may be utilized to implement portions of the techniques discussed herein, according to an embodiment. In one embodiment, the computing device 400 may be used to provide the digital camera processing unit 106 of FIGS. 1-2 and/or perform one or more of the stages of the method 300 of FIG. 3.

As shown in FIG. 4, the computing device 400 includes one or more processor(s) 108 (e.g., microprocessors, controllers, coprocessors, etc.), input/output interfaces 402 for the input and/or output of data, and user input devices 404. The processor(s) 108 process various instructions to control the operation of the computing device 400, while the input/output interfaces 402 provide a mechanism for the computing device 400 to communicate with other electronic and computing devices. The user input devices 404 may include a keyboard, mouse, pointing device, and/or other mechanisms to interact with, and to input information to the computing device 400.

The input/output interfaces 402 may include serial, parallel, and/or network interfaces. A network interface allows devices coupled to a common data communication network to communicate information with the computing device 400. Similarly, a communication interface, such as a serial and/or parallel interface, a universal serial bus (USB) interface, an Ethernet interface, an Institute of Electrical & Electronics Engineers (IEEE) 802.11 interface, and/or any combination of wireless or wired communication interfaces provides a data communication path directly (or through intermediate computing device(s) or network component(s)) between the computing device 400 and another electronic or computing device.

The computing device 400 may also include the volatile memory 110 and/or the nonvolatile memory 112 (such as discussed with reference to FIGS. 1 and 2), which may provide data storage mechanisms for the computing device 400. Any number and combination of memory and storage devices may be connected with, or implemented within, the computing device 400. Although not shown, a system bus may connect the various components within the computing device 400. Data may be transferred to/from memory (e.g., the memories 110 and 112) through the memory controller 216. The memory controller 216 may include the memory transfer engine 114. Alternatively, the memory transfer engine 114 may be provided in any suitable location internal or external to the computing device 400.

The computing device 400 may also include one or more application program(s) 406 and an operating system 408 which may be stored in volatile/nonvolatile memory (e.g., the memory 110 or 112) and executed on the processor(s) 108 to provide a runtime environment in which the application program(s) 406 may run or execute. The computing device 400 may also include an integrated display device 410, e.g., in embodiments where the computing device 400 is included in a suitable device, such as a scanner, a printer, a PDA, a cellular phone, a digital camera, or other portable/mobile computing devices.

Some embodiments discussed herein (such as those discussed with reference to FIGS. 1-4) may include various operations. These operations may be performed by hardware, software, firmware, and/or combinations thereof. Also, these operations may be embodied in machine-executable instructions, which are in turn utilized to cause a general-purpose or special-purpose processor, or logic circuits programmed with the instructions to perform the operations.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, those discussed with reference to memories 110 and/or 112, such as floppy diskettes, hard disk, optical disks, CD-ROMs, and magneto-optical disks, ROMs, RAMs, EPROMs, EEPROMs, magnetic or optical cards, flash memory, or other suitable types of media or machine-readable media that is capable of storing electronic instructions and/or data.

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a memory transfer engine to transfer a first data block from a nonvolatile memory to a volatile memory; and
a processor to decompress the transferred first data block,
wherein the memory transfer engine initiates a transfer of a second data block from the nonvolatile memory to the volatile memory prior to the processor completing the decompression of the transferred first data block.

2. The apparatus of claim 1, wherein the memory transfer engine comprises one or more of a multiplexer, a demultiplexer, or a switching controller.

3. The apparatus of claim 1, further comprising a memory controller that comprises the memory transfer engine.

4. The apparatus of claim 1, wherein the memory transfer engine comprises one or more of an ASIC or a PLA.

5. The apparatus of claim 1, wherein the nonvolatile memory comprises one or more of a ROM, an EPROM, an EEPROM, a CD-ROM, a DVD, a floppy disk, a tape, or a hard drive.

6. The apparatus of claim 5, wherein the EEPROM comprises flash memory.

7. The apparatus of claim 1, wherein the volatile memory comprises one or more of RAM, DRAM, SRAM, or SDRAM.

8. The apparatus of claim 1, wherein the nonvolatile memory comprises a plurality of data blocks.

9. The apparatus of claim 8, wherein the plurality of data blocks have a same size.

10. The apparatus of claim 8, wherein the plurality of data blocks are each about 16 kB.

11. The apparatus of claim 8, wherein the volatile memory comprises a plurality of data buffers to store the plurality of data blocks.

12. The apparatus of claim 1, further comprising a plurality of processors.

13. The apparatus of claim 1, wherein the apparatus is one or more of a digital camera, a PDA, a scanner, a printer, or a cellular phone.

14. A method comprising:
transferring a first data block from a nonvolatile memory to a volatile memory;
decompressing the transferred first data block; and
initiating a transfer of a second data block from the nonvolatile memory to the volatile memory prior to completing the decompression of the transferred first data block.

15. The method of claim 14, further comprising:
compressing data into a plurality of equal-sized data blocks; and
storing each of the plurality of equal-sized blocks in one of a plurality of data blocks in the nonvolatile memory.

16. The method of claim 15, wherein compressing the data into the plurality of equal-sized data blocks utilizes more time than decompressing the plurality of equal-sized data blocks.

17. The method of claim 14, wherein transferring the first data block comprises storing the first data block in a first data buffer in the volatile memory.

18. The method of claim 14, further comprising storing a plurality of data blocks in the nonvolatile memory.

19. The method of claim 18, further comprising transferring the plurality of data blocks to a plurality of data buffers in the volatile memory.

20. An apparatus comprising:
means for compressing data into a plurality of data blocks;
nonvolatile storage means for storing the plurality of data blocks;
means for transferring the plurality of data blocks to a volatile storage means; and
means for decompressing the transferred data blocks,
wherein the means for transferring transfers at least one of the data blocks while the means for decompressing decompresses a different one of the data blocks that has been transferred to the volatile storage means.

21. The apparatus of claim 20, further comprising means for determining whether one or more data blocks remain to be decompressed.

22. One or more computer-readable media having instructions stored thereon that, when executed, direct a machine to perform acts comprising:
transferring a first data block from a nonvolatile memory to a volatile memory;
decompressing the transferred first data block; and
initiating a transfer of a second data block from the nonvolatile memory to the volatile memory prior to completing the decompression of the transferred first data block.

23. The one or more computer-readable media of claim 22, wherein the acts further comprise:
compressing data into a plurality of equal-sized data blocks; and
storing each of the plurality of equal-sized blocks in one of a plurality of data blocks in the nonvolatile memory.
